(19) United States
(12) Patent Application Publication
(10) Pub. No.: US 2007/0211937 A1
(43) Pub. Date: Sep. 13, 2007

(54) Hybrid Image Compression Method

(76) Inventor: Juergen NEUMANN, Karlsruhe (DE)

Correspondence Address: BEEM PATENT LAW FIRM, 53 W. JACKSON BLVD., SUITE 1352, CHICAGO, IL, 60604-3787, US

(21) Appl. No.: 11/683,602

(22) Filed: Mar. 8, 2007

(30) Foreign Application Priority Data
Mar. 8, 2006 (DE) 10 2006 010 763.2

(51) Int. Cl. G06K 9/00

(52) U.S. Cl. 382/166

(57) ABSTRACT

According to the invention, a method is provided for the compression of image data, comprising: dividing an image which is to be compressed into a plurality of image sections; determining, for each image section, a compression method from a plurality of compression methods, by means of predetermined parameters; and compressing the image data of each image section by means of the respectively determined compression method. By dividing an image which is to be compressed into a plurality of areas or sections, a suitable compression method can be allocated to each image section. In particular, the plurality of compression methods comprises a lossless compression method and a lossy compression method. For image sections which consist predominantly of text, a lossless compression method is selected. For image sections which consist predominantly of graphic representations, a lossy compression method is selected.

This application claims the benefit of priority of German Patent Application 10 2006 010 763.2 filed on Mar. 8, 2006.

### DESCRIPTION

The present invention relates to a method for the compression of image data, in particular a hybrid image compression method for the compression of mixed screen contents.

### BACKGROUND OF THE INVENTION

In the transfer of electronically stored images, particularly of screen contents, it is desirable to carry out a compression of the image data before the transfer, in order to thus reduce the amount of data which is to be transferred. The data load of the network which is used for the image transfer and the transfer time are thereby reduced. The latter is particularly desirable in the case of slow data connections.

Three factors are usually to be considered in the compression of image contents:
1. Time expenditure/calculation effort for the compression: how much calculation effort must be made in order to compress an image by a compression method?
2. Compression factor: how great is the quotient of “original data quantity” and “compressed data quantity”?
3. Is the compression method lossy i.e. is image detail information lost through the compression?

Compression methods are known which are subject to losses (e.g. JPG, Wavelet compression), which are suitable in particular for the transfer of digital photos. Very good compression rates are achieved here, in which the artefacts occurring on compression/decompression are only poorly visible to the human eye.

However, lossy compression methods are less suitable for the transfer of text images: firstly, the compression rates are lower (as there is more “hard” change of brightness between adjacent pixels) ; secondly, the transfer artefacts which occur are clearly visible to the human eye.

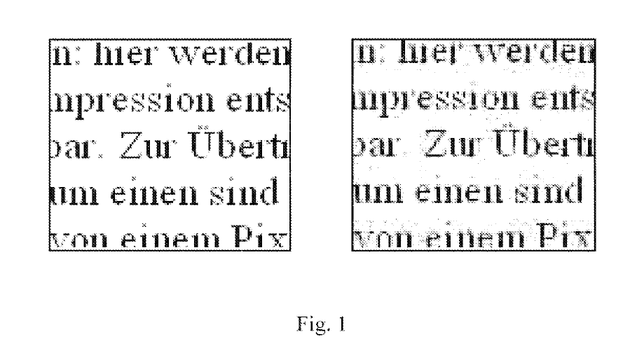

FIG. 1 shows by way of example a text image in the original on the left, and after a compression in JPG format on the right. The shadows or streaks can clearly be seen at the edges of the individual letters.

So-called lossless methods are therefore better suited for text images (e.g. GIF, PNG), which achieve a high compression rate. However, in the compression of digital photos, they only achieve very poor compression rates.

In many applications, screen contents must be compressed and transferred, which consist of a mixture of (monochrome) texts and (polychrome) images (photographs) Scheduling in advance a lossless compression method or a lossy compression method therefore leads to individual image areas being compressed by an “unsuitable” method.

On the basis of this knowledge, it is an object of the present Invention to at least reduce the disadvantages of the prior art.

### SUMMARY OF THE INVENTION

In accordance with the invention, a method is provided for the compression of image data, comprising: Dividing an image which is to be compressed into a plurality of image sections; determining, for each image section, a compression method from a plurality of compression methods, by means of predetermined parameters; and compressing the image data of each image section by means of the respectively determined compression method.

By dividing an image which is to be compressed into a plurality of areas or sections, a suitable compression method can be allocated to each image section. In particular, the plurality of compression methods comprises (at least) one lossless compression method and (at least) one lossy compression method. For image sections which consist predominantly of text, a lossless compression method can be selected. Accordingly, for image sections which consist predominantly of graphic representations, a lossy compression method can be selected. As a whole, therefore, the compression rate and the quality of the overall image are improved after its compression and decompression.

Consequently, the invention overcomes the main disadvantage of the prior art, according to which images which are to be transferred are compressed in their entirety (i.e. as one unit) in a predetermined compression method. In accordance with the method according to the invention, on the other hand, cohesive images are broken down into individual areas and the areas are analysed individually as to whether they (respectively individually) are to be transferred losslessly or lossily in compressed form. The individual areas are then subsequently compressed sequentially by means of the respectively suitable method. This is advantageous particularly in “mixed” image contents (e.g. screenshot of an internet browser with text and photo components; desktop contents). It is therefore to be noted that the method according to the invention can be applied to images which are stored within individual image files. This means that separate image files are not compressed differently, but rather within image files which are to be compressed, different compression methods are used.

According to a development of the invention, a differentiation is made between a first and a second image type. Each image section is allocated either to the first or the second image type. The image data of all image sections of the first image type are then compressed by means of a lossless compression method, and the image data of all image sections of the second image type are compressed by means of a lossy compression method. In particular, image sections which contain predominantly text are allocated to the first image type. Image sections which consist predominantly of graphic representations are allocated to the second image type.

The differentiation of the image types can take place for example by means of the number of colours. To do this, the number of colours is determined in all the image sections. Image sections which contain less than a predetermined first number of colours (e.g. text) are allocated to the first image type. Image sections which contain more than a predetermined second number of colours (e.g. coloured graphic representations) are allocated to the second image type. The image data of all the image sections of the first image type are then compressed by means of the lossless compression method, and the image data of all the image sections of the second image type are compressed by means of the lossy compression method.

The first number of colours is preferably less than the second number of colours. Thereby, a “hysteresis” can be created, which concerns the correlation between the image section content and the selection of the compression method, i.e. a “switching to and fro” between different compression methods with similar contents of adjacent image sections can be avoided.

In an advantageous development of the invention, each image section whose number of colours is greater than the said first number of colours and less than the said second number of colours is accordingly compressed by means of the compression method determined for the last compressed image section.

Preferably, the suitable compression method for each image section is determined before the compressing of the image sections. Thereby, image sections for which the same compression method has been determined can be compressed collectively, whereby the processing effort can be reduced.

In particular, image sections which are adjacent to each other and for which the same compression method has been determined, can be compressed collectively. Such image sections can be joined together, as it were, before compression, in order to reduce the compression expenditure. This is particularly advantageous in the case of image sections which are adjacent to each other, for which a lossless compression method has been determined, because thereby the compression factor is increased.

In addition; a data processing device is provided according to the invention, which is adapted to carry out the method described above.

According to the invention, in addition a program is provided, which contains machine-readable instructions to carry out the method described above on a data processing device.

Furthermore, a memory medium is provided according to the invention, with a machine-readable program stored thereon in accordance with the preceding paragraph.

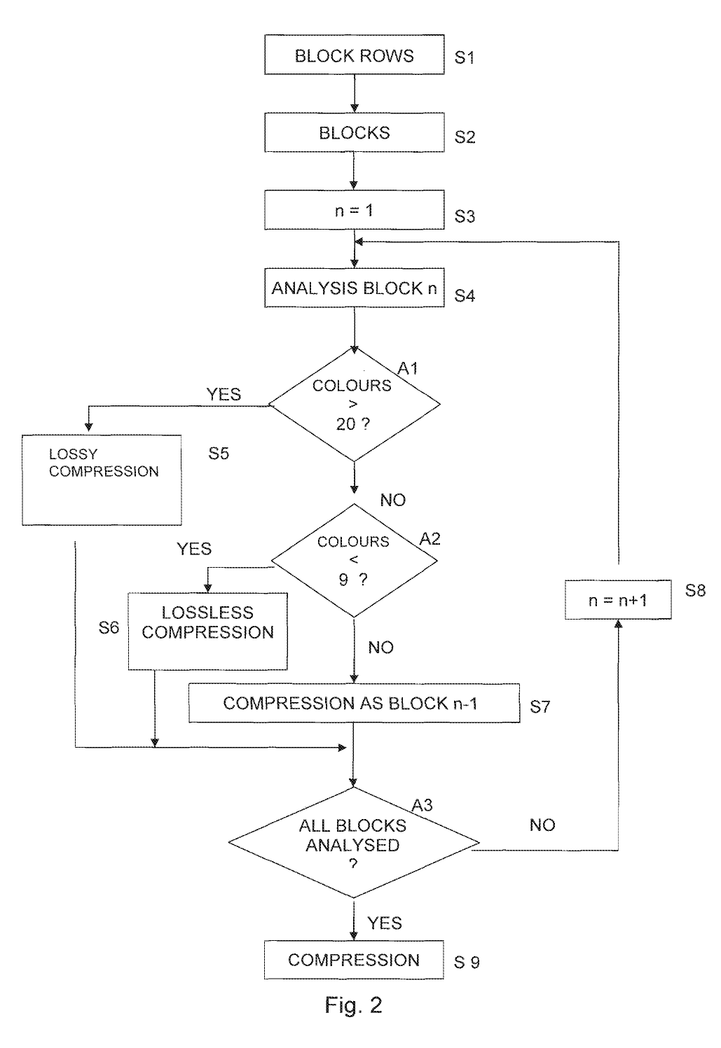

The invention is now described with the aid of an example embodiment with reference to FIG. 2.

In step S1, an image which is to be transferred is broken down in its entirety into block rows. The block rows consist of eight lines in each case. In step S2, each block row is broken down into sections of 8 pixels each. The entire image is therefore divided into image blocks each of 8 times 8 pixels.

Subsequently, the number of different colours is determined for each image block (step S4, with iteration by step S3, query A3 and step S8). If the number of colours is greater than 20 (i.e. a predetermined first limit value), then this block is provided for a lossy compression (query A1 and step S5). If the number of colours is less than 9 (i.e. a predetermined second limit value, then this block is provided for a lossless compression (query A2 and step S6). If the number of colours lies between 9 (the second limit value) and 20 (the first limit value), then this block is provided for the same type of compression as the last block which was analysed (step S7).

Each image block is then compressed according to the previously allocated method (step S9).

Through the complete separation of analysis and compression, it is possible to extend the lossless compression over a row of N adjacent blocks, for which a lossless compression is to be carried out. In this case, it is not N blocks with 8 times 8 pixels that are compressed, but rather only one block with (N*8) times 8 pixels. This has a positive effect on the compression factor in lossless compression methods.

In lossy compression, the blocks 8 times 8 pixels) are respectively compressed individually. This corresponds for example to the procedure in the known JPG method.

1. A method for the compression of image data, comprising:
dividing an image which is to be compressed into a plurality of image sections;
determining a first image type as an image type with less than a predetermined first number of colours;
determining a second image type as an image type with more than a predetermined second number of colours;
determining the number of colours within each image section;
allocating each image section to the first or second image type, depending on the number of colours within the respective image section;
compressing the image data of all image sections of the first image type by means of a first compression method; and
compressing the image data of all image sections of the second image type by means of a second compression method.

2. The method according to claim 1, in which the first and second compression methods are formed by a lossless compression method and a lossy compression method.

3. The method according to claim 1, in which the first number of colours is less than the second number of colours.

4. The method according to claim 3, comprising:
compressing an image section by means of the compression method which was determined for the last compressed image section when the number of colours of this image section is greater than the first and smaller than the second number of colours.

5. The method according to claim 1, comprising determining a compression method for each image section before the compressing of all the image sections.

6. The method according to claim 5, comprising the collective compressing of image sections adjacent to each other, for which the same compression method has been determined.

7. The method according to claim 2, comprising the collective compressing of adjacent image sections, for which a lossless compression method has been determined.

8. The method according to claim 1, in which the image data of the image which is to be compressed are contained within an image files.

9. The method according to claim 1, in which the image which is to be compressed is formed by a screen content (screenshot).

10. A data processing device which is adapted to carry out the method according to claim 1.

11. A program comprising machine-readable instructions to carry out the method according to claim 1 on a data processing device.

12. A memory medium with a machine-readable program according to claim 11 stored thereon.
